(19) United States
(12) Patent Application Publication
(10) Pub. No.: US 2022/0099127 A1
(43) Pub. Date: Mar. 31, 2022

(54) ENCAPSULATED ADHESIVE

(71) Applicant: Steven S. Baik, Alviso, CA (US)

(72) Inventor: Steven S. Baik, Alviso, CA (US)

(21) Appl. No.: 17/133,191

(22) Filed: Dec. 23, 2020

Related U.S. Application Data
(60) Provisional application No. 63/083,660, filed on Sep. 25, 2020.

(51) Int. Cl. F16B 13/14

(52) U.S. Cl. CPC F16B 13/144; F16B 2013/147

(57) ABSTRACT

An encapsulated adhesive for easy handling and a method of making the encapsulated adhesive are presented. The encapsulated adhesive includes an adhesive material enclosed by a non-adhesive encapsulant that substantially surrounds the adhesive material. The encapsulant is strong enough to withstand handling and storage, but breaks in response to pressure, exposing the adhesive material. A method of bonding two pieces by forming a first cavity in a first piece, inserting the encapsulated adhesive into the first cavity, and inserting a member into the first cavity to breach the encapsulant is also presented.

### CROSS-REFERENCE TO RELATED APPLICATION(S)

This applications claims the benefit of U.S. Provisional Application No. 63/083,660 filed on Sep. 25, 2020, the content of which is incorporated by reference herein.

### BACKGROUND

This disclosure pertains generally to adhesives, and particularly to a method and apparatus for applying adhesives.

Adhesives, or glue, are widely used in a variety of applications to bond or attach two or more objects together. While adhesives are extremely useful, handling of adhesives is burdensome because they may stick to objects in a nondiscriminatory manner and result in spillage. Hence, adhesives usually come packaged in a container or tube with a built-in closable opening through which the adhesive can be dispensed in a controlled manner. The packaging makes the adhesive easy to transport, store, and use.

Even with the packaging, however, the adhesive can still be difficult to apply. One example of such a situation where use of adhesive is frequently omitted in spite of its advantages is in assembling of flat pack furniture or accessories using mortise-and-tenon or dowel-and-hole construction. A mortise-and-tenon type joint attaches two members together by having the tenon/dowel pushed into the mortise/hole of a member. The attachment is as secure as the tightness of the fit. Although the attachment could be significantly strengthened by use of an adhesive between the tenon/dowel and the mortise/hole, the adhesive is often avoided due to a typical user's lack of ability to properly apply the adhesive. As a result, the furniture or accessory that is assembled may suffer loss of structural integrity over time, as the joint loosens.

While flat pack furniture often comes packaged with small tools such as a screwdriver, screws, allen wrench, or wrench, an adhesive is usually not included. Adhesive is often not included due to the potential mess it can make if it leaks during storage or transport, and also because its method of application can make it challenging to use by a typical consumer. If the user is not careful enough or skilled enough, the adhesive may possibly even ruin parts of the furniture.

A method and apparatus for controlled application of adhesives is desired.

### SUMMARY

In one aspect, the inventive concept pertains to an encapsulated adhesive including an adhesive material and a non-adhesive encapsulant surrounding and holding the adhesive material. The encapsulant is a layer that is formed around the adhesive material.

In another aspect, the inventive concept pertains to a method of making an encapsulated adhesive. The method entails mixing an adhesive material with a first reactant to form an adhesive mixture, and placing the adhesive mixture in contact with a second reactant to form an encapsulant around the adhesive mixture in a spherical shape. Each of the first reactant and the second reactant is one of sodium alginate and calcium chloride.

Containing the adhesive within an encapsulant makes the adhesive easier to store, transport, and use.

### DESCRIPTION OF THE DRAWINGS

FIG. 1 depicts an encapsulated adhesive in accordance with an embodiment of the inventive concept.

FIG. 2 depicts a method of making the encapsulated adhesive in accordance with an embodiment of the inventive concept.

FIG. 3 depicts another example method of making the encapsulated adhesive.

FIG. 4A depicts a method of making the encapsulated adhesive in accordance with another embodiment of the inventive concept.

FIG. 4B depicts another method of making the encapsulated adhesive in accordance with another embodiment of the inventive concept.

FIG. 5 depicts an example use of the encapsulated adhesive.

FIG. 6A, FIG. 6B, and FIG. 6C depict another example use of the encapsulated adhesive.

FIG. 7A depicts the encapsulated adhesive 10 in accordance with an embodiment of the inventive concept.

FIG. 7B depicts the encapsulated adhesive 10 in accordance with an embodiment of the inventive concept.

FIG. 8 depicts the encapsulated adhesive 10 in accordance with an embodiment of the inventive concept.

FIG. 9 depicts the encapsulated adhesive 10 in accordance with an embodiment of the inventive concept.

FIG. 10A, FIG. 10B, and FIG. 10C depict an embodiment of the encapsulated adhesive 10 in accordance with an embodiment of the inventive concept.

FIG. 11A, FIG. 11B, FIG. 11C, FIG. 11D, FIG. 11E, FIG. 11F, and FIG. 11G depict different shapes for the encapsulated adhesive.

FIG. 12A and FIG. 12B depict the encapsulated adhesive in accordance with different embodiments of the inventive concept.

FIG. 13 depicts the encapsulated adhesive in accordance with an embodiment of the inventive concept.

FIG. 14 depicts the encapsulated adhesive 10 in accordance with an embodiment of the inventive concept.

FIG. 15A, FIG. 15B, FIG. 15C, FIG. 15D, and FIG. 15E depict an embodiment of a dowel that may be used with the encapsulated adhesive.

FIG. 16A and FIG. 16B depict the encapsulated adhesive in accordance with an embodiment of the inventive concept.

### DETAILED DESCRIPTION

The inventive concept pertains to a method for preparing an adhesive that is easy to handle, and the adhesive prepared in such manner. There are many types of adhesive material. One embodiment of the present invention utilizes non-water-based adhesive material such as epoxy, polyurethane, cyanoacrylate (crazy glue), polyvinyl acetate (e.g., white glue) without adding water, aliphatic glue (e.g., wood glue) without adding water, and animal/hide glue, it should be understood that the inventive concept disclosed herein may be adapted to be used with other types of adhesive material. Non-water-based adhesive, in one aspect of the present invention, may be paired with any suitable encapsulant. In another embodiment, water based adhesives may be utilized, preferably be paired with a non-water permeable encapsulant, such as a plastic or polymer, or glass. More generally, the present invention may be implemented with any adhesive contained in a suitable encapsulant. The encapsulant may be comprised of gelatin, calcium alginate, plastic, polymer, glass, ceramic, metal, composites, fiberglass, carbon fiber, or any combinations thereof. The encapsulant may be formed in one or more layers of different materials.

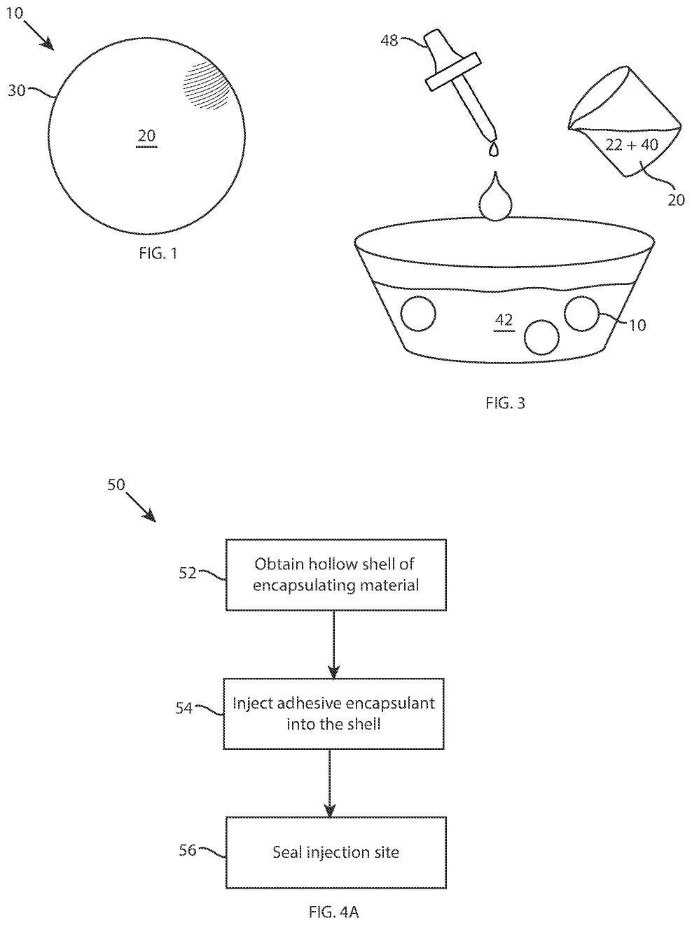

FIG. 1 depicts an encapsulated adhesive 10 in accordance with an embodiment of the inventive concept. As shown, the encapsulated adhesive 10 includes an adhesive mixture 20 contained in an encapsulant 30. The adhesive mixture 20 includes an adhesive material and any additives (e.g., to achieve the desired consistency, pH, color). The encapsulant 30 is not sticky or adhesive, and may withstand a low level of pressure or impact. The encapsulant 30 may be a flexible polymer material such as calcium alginate, gelatin, or a brittle material such as glass or plastic. The encapsulation makes the handling of the adhesive mixture 20 easier.

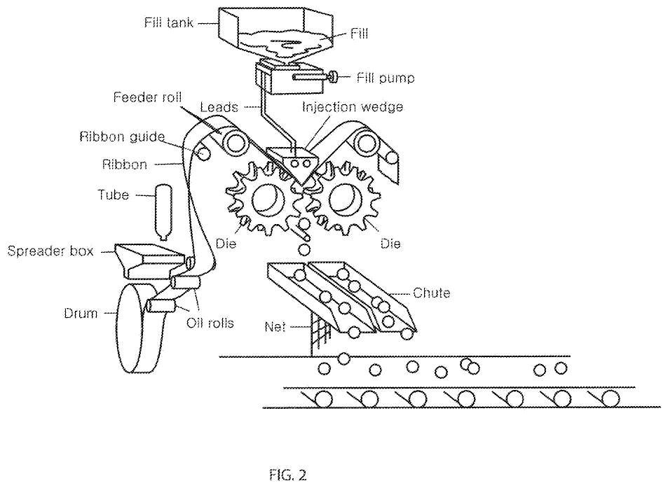

FIG. 2 depicts a method of making the encapsulated adhesive 10 in accordance with an embodiment of the inventive concept. In this embodiment, the encapsulated adhesive 10 is prepared using specialized equipment such as what is used for making paint balls. In the example depicted in FIG. 2, two strips of encapsulant material (e.g., softened plastic or gelatin) are loaded onto the feeder rolls. The adhesive mixture 20 is placed in the fill tank so that a precisely measured amount of adhesive mixture 20 can be injected into an area between two counter-rotating drums 12. The drums 12 are lined with pockets or dimples that form the encapsulant 30. As the gelatin ribbon is pushed into the dimple, the dimple automatically receives the measured amount of adhesive mixture 20 and the machine seals two strips together to surround the adhesive material.

The balls of encapsulated adhesives 10 may be soft coming out of the chute. They are cooled, hardened, and dried in a tumbling machine. The tumbling machine may also make the balls uniformly round or cylindrical. Further drying time may be needed.

FIG. 3 depicts a method of making the encapsulated adhesive 10 in accordance with an embodiment of the inventive concept. An off-the-shelf glue or adhesive material 22, which is in liquid form, is mixed with a first reactant 40 and any other additives to make an adhesive mixture 20. In the example depicted in FIG. 2, the first reactant 40 is calcium chloride (CaCl₂), which is usually solid under ambient conditions. When the calcium chloride is mixed with the adhesive material 22, which is usually in liquid form, the resulting adhesive mixture 20 is liquid. Using a tool such as an eye dropper type dispenser 48, the adhesive mixture is dropped into a pool of second reactant 42, which may be mixed with water. The second reactant may be sodium alginate (NaC₆H₇O₆) in the example of FIG. 2. In some embodiments, the first reactant 40 may be sodium alginate and the second reactant may be calcium chloride, with surrounding chemicals interchanged as well.

In the embodiment of FIG. 3, the first reactant 40 and the second reactant 42 are switched relative to the above example. Hence, the sodium alginate (the first reactant 40 in this example) in powder form is mixed with the adhesive material 22 to make an adhesive mixture 20. The adhesive mixture 20 is then placed in contact with the second reactant 42, which is calcium chloride in this example. This contact may be made by using an eye dropper 48 to add drops of the adhesive mixture 20 into a pool of calcium chloride, which may be mixed with water.

Upon contact, the sodium alginate (NaC₆H₇O₆) and calcium chloride react as shown below to make calcium alginate:

2NaC₆H₇O₆+CaCl₂→2NaCl+CaCl₂H₁₄O₁₂

Calcium alginate is a gelatinous substance that is not sticky in itself. As the chemical reaction happens, the liquid drops that fell into the pool of second reactant turn into discrete, gelatinous “balls” through a spherification process, resulting in balls of encapsulated adhesive 10. The encapsulant 30 is formed around the adhesive mixture, so that there is no empty space between the encapsulant 30 and the adhesive mixture 20. The encapsulated adhesive 10 is easy to handle as the adhesive is contained inside a non-sticky encapsulant 30. When pressure is applied to the encapsulated adhesive 10, the gelatinous encapsulation breaks, letting out the adhesive material.

Depending on the exact pH of the adhesive material that is used, the spherification process might be challenging. To fine tune the pH level of an adhesive, certain additives that are basic or acidic (e.g., sodium citrate, lemon juice, baking soda) may be added to the adhesive mixture 20 before being placed in contact with the second reactant. To achieve the desired consistency, polyethylene glycol (PEG) or water may be added to the adhesive mixture, depending on the type of adhesive material being used. Crayon wax may be added as a thickening agent. Mineral oil and coloring may also be added.

Due to their gelatinous, semi-liquid nature, the encapsulated adhesive 10 is difficult to shape. For example, if one wanted adhesives in a rod shape, it would be difficult to produce encapsulated adhesive 10 in the desired shape. Optionally, the balls of encapsulated adhesive 10 may be cooled to be semi-solidified, so that they can be shaped in a desired manner. After the shaping or molding is done, the encapsulated adhesive 10 can be frozen to retain the shape.

Regardless of whether the cooling and freezing process is performed, the encapsulated adhesive 10 may be dipped into a harder shell material to prevent it from breaking under too little pressure. Coating with lacquer, acrylic or epoxy, followed by curing, may be done to form the shell around the encapsulated adhesive 10.

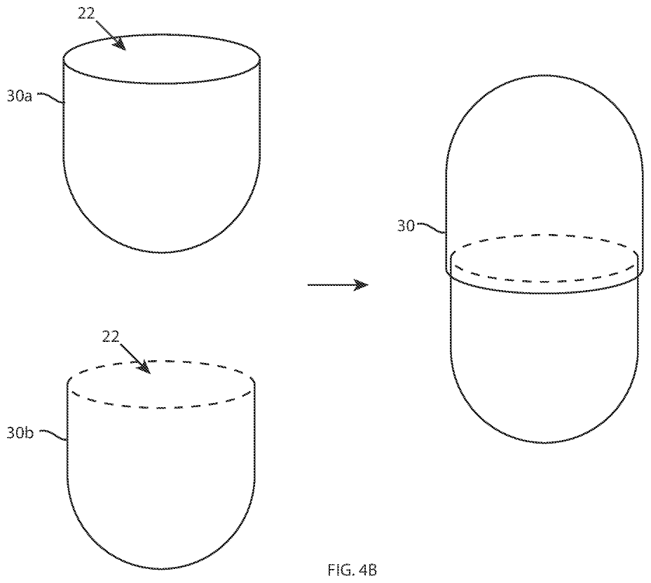

FIG. 4A depicts a method 50 of making the encapsulated adhesive 10 in accordance with another embodiment of the inventive concept. In this embodiment, a hollow shell made of rubber, plastic or glass is obtained (52), and the adhesive material 22 is injected into the hollow shell (54) and sealed (56). The sealing may be done by coating the injection site with a material that hardens upon drying, or with acrylic or epoxy, and then being cured.

FIG. 4B depicts another method of making the encapsulated adhesive 10 in accordance with another embodiment of the inventive concept. In this embodiment, the encapsulant 30 is a capsule (or sphere, or any other suitable shape) that is separable into two parts 30a, 30b. The adhesive material 22 is placed in one or both of the capsule parts 30a, 30b, and the two capsulate parts 30a, 30b are combined to form a closed space holding the adhesive material 22. The adhesive material 22 that is used may be viscous, to avoid or minimize spillage during the combination process. In one such embodiment, capsulate parts 30a and 30b can be comprised of commonly available gelatin capsulate parts, and utilized with non-water based adhesive materials 22 (due to the solubility of gelatin in water). Alternatively, capsulate parts 30a and 30b comprised of gelatin can be coated with a waterproofing material, such as a non-water based epoxy, urethane, plastic or other suitable materials. As noted, the capsulate parts can also be comprised of a non-water soluble material, such as plastic, permitting the use of any suitable adhesive material 22.

FIG. 5 depicts an example use of the encapsulated adhesive 10. In this example, an encapsulated adhesive 10 is placed at a desired position on a flat surface, and an object is pushed down onto the encapsulated adhesive 10. The encapsulant 30 is broken due to the pressure, the adhesive material 22 is exposed, and the object is attached to the flat surface.

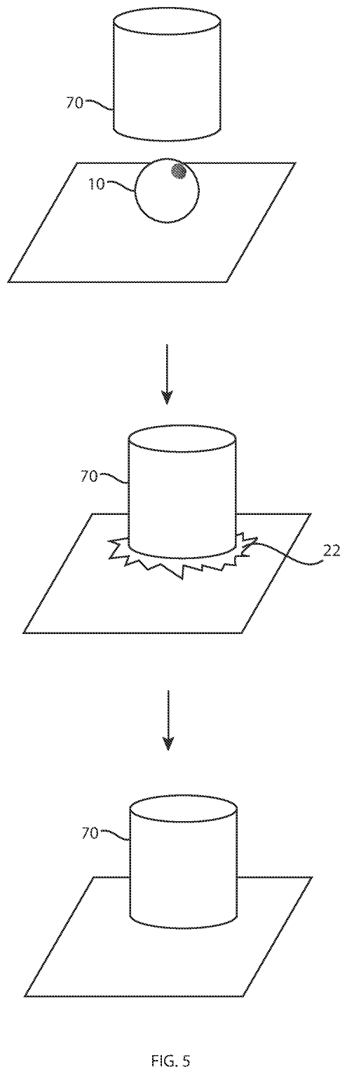

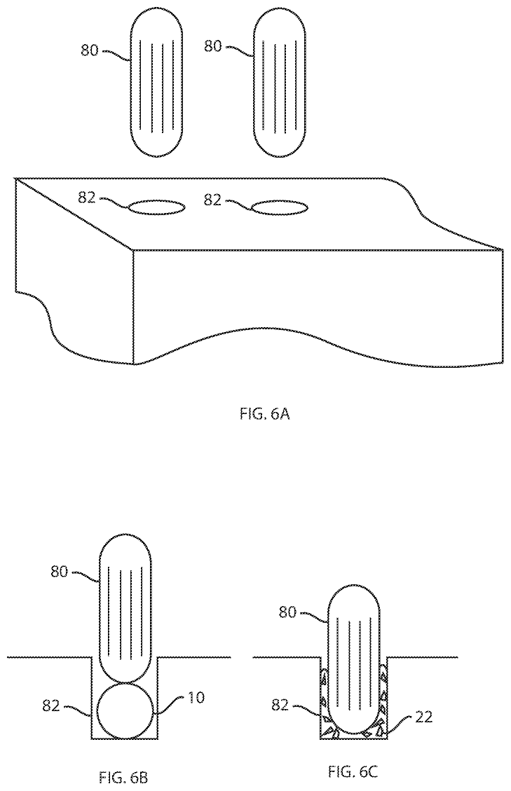

FIG. 6A, FIG. 6B, and FIG. 6C depict another example use of the encapsulated adhesive 10. FIG. 6A depicts dowels 80 that are designed to fit into dowel holes 82. This type of mortise-tenon or dowel-hole configuration is a common way to attach two parts together, for example during the assembly of flatpack furniture. To securely attach the dowel 80 into the dowel hole 82, an encapsulated adhesive 10 is placed in the dowel hole 82 before the dowel 80 is inserted. When the dowel 80 is pushed into the dowel hole 82, the pressure of the dowel breaks the encapsulation, allowing the adhesive material 22 to fill the space between the dowel 80 and the inner walls of the dowel hole 82. When the adhesive material 22 dries and hardens, the dowel 80 is securely attached to the dowel hole 82.

In another embodiment, encapsulated adhesive 10 may be applied to tongue and groove assembly. In such an application, the encapsulated adhesive may be formed in an elongated tube that is inserted into the groove. Upon joining a tongue piece into the groove piece, the encapsulated adhesive 10 is released from the encapsulant, bonding the tongue and groove pieces upon curing. Similarly, instead of a single long tube encapsulated adhesive, several smaller encapsulated adhesives 10 may be applied within the groove.

More recently, a joinery system using wedge dowels was developed. Wedge dowels are typically ribbed (annularly around the circumference of the dowel) rather than relatively smooth. The ribbed dowels are inserted into a hole or cavity with a wider end into which the ribbed dowel can be inserted. The ribbed dowel can then be moved into a narrower portion of the hole or cavity, where corresponding matching wedges are formed in the inner walls of the hole or cavity. As the ribbed dowel is pushed into the tighter region with matching ribs, the ribs form an interlocking joint. In one embodiment of the present invention, an encapsulated adhesive 10 can be inserted into the narrower (or ribbed) end of the hole or cavity. When the ribbed dowel is pushed into the narrower end, the encapsulated adhesive can be ruptured releasing the adhesive material 22 within. In one aspect of the present invention, the encapsulated adhesive can be formed to rupture in a manner to provide greater coverage of the adhesive material between the ribbed dowel and the inner wall of the hole or cavity. Wedge or ribbed dowels can be in many shapes, such as a ribbed wedge or ribbed dowel, with matching shaped hole or cavity, the hole or cavity having an insertion end with no ribs and a narrower or ribbed end with ribs. An encapsulated adhesive 10 may be inserted in the narrower or ribbed end. Accordingly, the encapsulated adhesive 10 may also be ribbed to be easily inserted in the narrower or ribbed end of the hole or cavity. The encapsulated adhesive 10 can also be shaped to match the geometry of the ribbed dowel and cavity, such as a wedge or cylinder. Also, the encapsulated adhesive 10 may be designed in a manner to provide flow of the adhesive material between the ribbed dowel and the hole/cavity. The design may include the shape of the encapsulated adhesive, the use of scoring or perforations, or the positioning of the encapsulated adhesive in the hole or cavity.

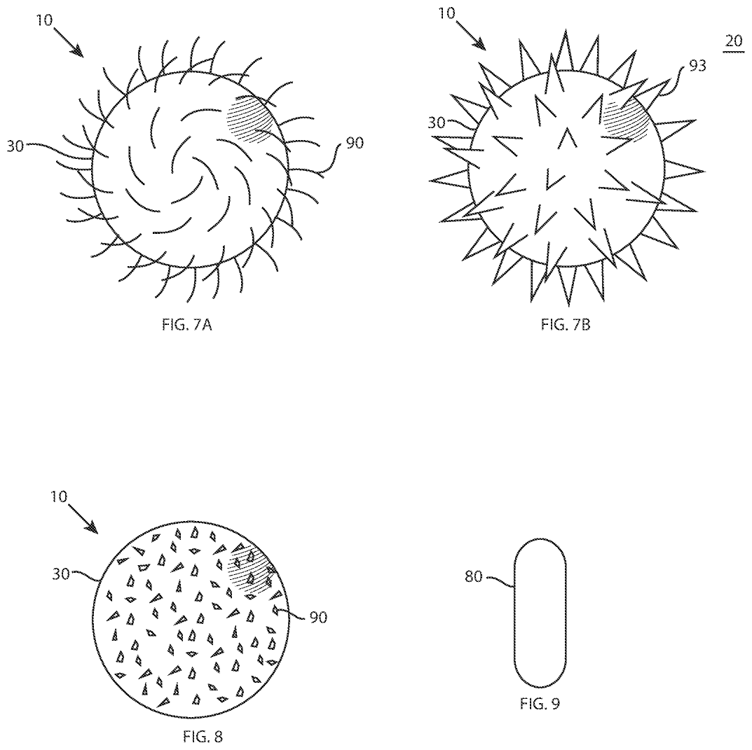

FIG. 7A and FIG. 7B show embodiments of encapsulated adhesive 10 with an outer layer. FIG. 7A depicts the encapsulated adhesive 10 in accordance with an embodiment of the inventive concept. The embodiment of FIG. 7A has fibers 90 attached to the surface of the encapsulant 30. The fibers 90 may be fiber glass or carbon fiber, and form an outer layer of the encapsulated adhesive 10. The fibers 90 make the encapsulated adhesive 10 easier to handle, and also helps the encapsulated adhesive 10 stay where they are placed. For example, referring to FIG. 6A, the “fuzzy” texture of the fibers 90 make it less likely that the encapsulated adhesive 10 will roll out of the dowel hole 82. The fibers 90 can be applied to the encapsulant in any number of ways. For example, after formation of the encapsulated adhesive 10, an adhesive can be applied to the encapsulated adhesive and the fibers 90 can applied and allowed to cure to form the outer layer. In another embodiment where an encapsulating machine is used, such as one similar to those used in the manufacture of paint balls, the fibers 90 may be applied to the exterior facing surfaces of the encapsulating layers, which are then fed into the machine.

FIG. 7B depicts the encapsulated adhesive 10 in accordance with an embodiment of the inventive concept. As shown, this embodiment has spikes 93 on the surface of the encapsulant 30 as an outer layer. Similarly to the fibers 90 of FIG. 7A, the spikes 93 serve to help the encapsulated adhesive 10 stay in place. The spikes 93 may be made of any suitable material to assist in providing a stronger joint, such as fiberglass, cellulose (e.g., wood or paper fibers), carbon fibers, cured epoxy, plastic, ceramic, metal, etc. The spikes 93 can be applied to the encapsulated adhesive in a manner similar to the application of fibers, as discussed above.

FIG. 8 depicts the encapsulated adhesive 10 in accordance with an embodiment of the inventive concept. In this embodiment, fibers 90 are added to the adhesive mixture 20 that is held inside the encapsulant 30. The fibers 90 may be carbon fiber or fiber glass or other suitable materials. The fibers 90 are mixed in with the adhesive material 22 to make the adhesive mixture 20. The fibers 90 help in creating a stronger bond between the two pieces being joined. In the present embodiment, fibers 90 are included in the mixture 20. However, any suitable type of aggregate that assist in creating a bond between two pieces may be used.

FIG. 9 depicts the encapsulated adhesive 10 in accordance with an embodiment of the inventive concept. The embodiment of FIG. 9 has an elongated or cylindrical shape instead of a spherical shape. This shape may be achieved, as mentioned above, by cooling, shaping, and solidifying the encapsulated adhesive 10. To retain the shape at warmer temperature, the encapsulated adhesive 10 may be coated with a hard shell while it is frozen. In another embodiment, when an encapsulating machine is used to form the encapsulated adhesive, the two layers of encapsulant can be formed into half cylinders, which are then joined together and filled.

FIG. 10A depicts an embodiment of the encapsulated adhesive 10 in accordance with an embodiment of the inventive concept. This embodiment has a pin 95 inside the encapsulant material 30. The pin 95 is shaped so that when compressed, it expands in one or more directions and breaks the encapsulant 30. Hence, in the dowel-hole application that is illustrated in FIG. 10B and FIG. 10C, pushing the dowel into the dowel hole 82 with the encapsulated adhesive 10 inside the hole 82 would cause the pin 95 to expand and break the encapsulant material 30, allowing the adhesive material 22 to contact the dowel 80 and the inner wall of the dowel hole 82. In an embodiment where spherification is utilized to form the encapsulated adhesive, the pin can be dispensed along with the adhesive in the second reactant mixture. In another embodiment where an encapsulating machine is utilized, the pin can be inserted when the adhesive is filled into the joined halves of the encapsulant. The pin may also be configured in a suitable configuration, such as a square (two dimension) or cube/cuboid (three dimension)(or any suitable shape), to increase the likelihood of the pin being compressed when a dowel/member 80 is inserted into the dowel hole/cavity 82.

As illustrated in FIG. 10B and FIG. 10C, the encapsulated adhesive 10 is placed in a cavity 82, and a dowel/member 80 is inserted into the cavity. As the dowel/member 80 reaches and presses the encapsulated adhesive 10, the pin 95 gets compressed and breaches the encapsulant 30. Alternatively or in addition, pin 95 may be added to the cavity 82 separately from the encapsulated adhesive 10 so that when the member 80 presses down on the pin 95 and the encapsulated adhesive 10, the encapsulant 30 will be breached.

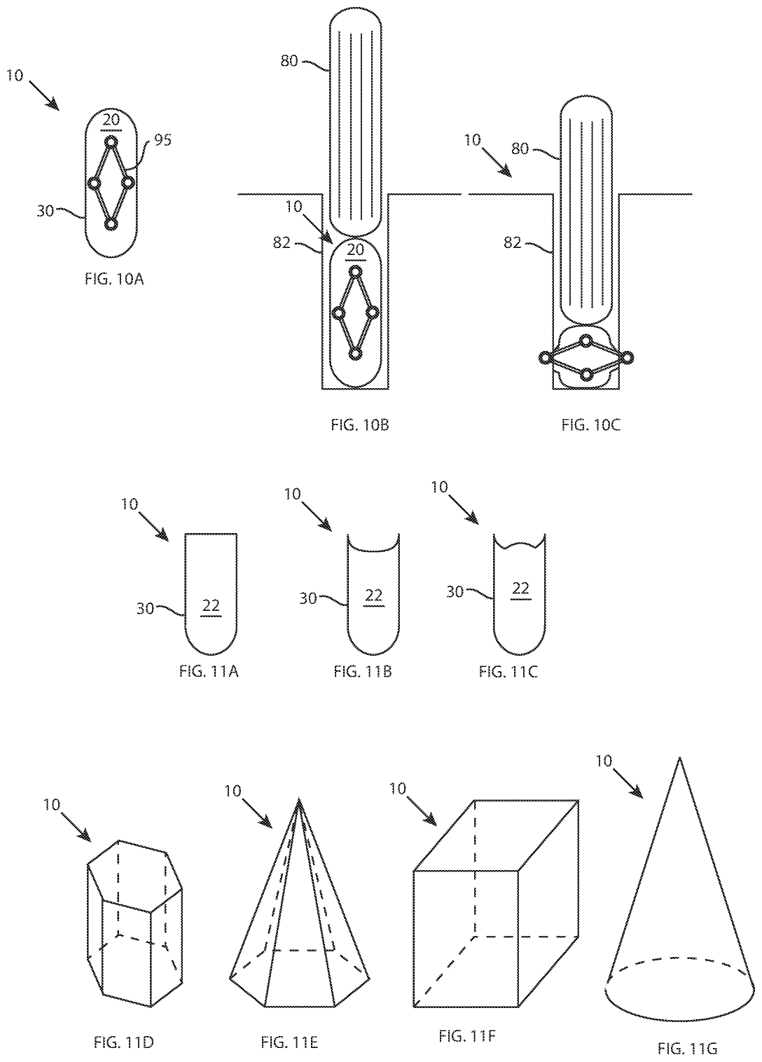

FIG. 11A, FIG. 11B, FIG. 11C, FIG. 11D, FIG. 11E, FIG. 11F, and FIG. 11G depict different shapes for the encapsulated adhesive 10. The shaping may happen by controlling the temperature and coating with a hard shell, as described above. The shapes depicted in FIG. 11A, FIG. 11B, and FIG. 11C may be used with a dowel-and-hole application. For example, the encapsulated adhesive of FIGS. 11A, 11B, and 11C may be sized to be slightly less wide than the size of a dowel hole and placed inside the dowel hole to be “standing up.” The bottom may be shaped to match the base of the dowel hole (e.g., rounded, flat, etc.), and the top surface may be shaped to receive the dowel and break easily. FIG. 11D, FIG. 11E, FIG. 11F, and FIG. 11G depict polygonal or prism shapes of encapsulated adhesive 10, which may be advantageous in various applications. The different shapes that are shown are not meant to be exhaustive; rather, they are provided to demonstrate that there is no limit to the shapes that can be used for the encapsulated adhesive 10.

FIG. 12A and FIG. 12B depict the encapsulated adhesive 10 in accordance with different embodiments of the inventive concept. These embodiments have scoring/perforation 100 on the surface of the encapsulant 30 to make the breaking of the encapsulant 30 predictable. For example, the scoring may ensure that the encapsulant 30 will break into small pieces. The scoring 100 may be done by laser or mechanically onto an encapsulated adhesive 10 that is prepared. The dents or holes of the scoring 100 should not be big enough to allow any adhesive material 22 to leak out. Scoring may be performed in any pattern, either decorative or functional. In a functional aspect, scoring may be applied to the encapsulant in any pattern such that the adhesive is released sufficiently around the collapsed encapsulant, such that the adhesive is applied evenly to the surfaces of both pieces (e.g., mortise and tenon, dowel and hole, or tongue and groove). For example, in an embodiment utilizing a cylindrical encapsulated adhesive, scoring may be applied in a spiral pattern such that the encapsulant is released around the entire surface of the cylinder, coating the surfaces of the two pieces to be bonded and the remaining encapsulant acting as aggregate material.

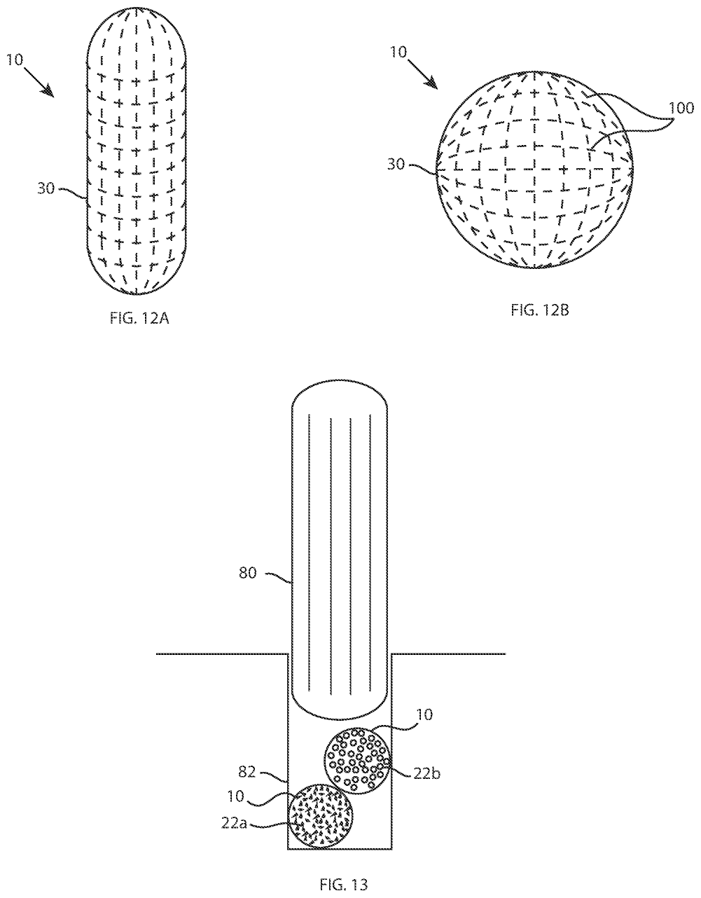

FIG. 13 depicts the encapsulated adhesive 10 in accordance with an embodiment of the inventive concept, wherein each encapsulated adhesive 10 contains one chemical component of a multi-part epoxy, e.g., a two-part epoxy. A two-part epoxy involves two substances, neither of which is adhesive on its own, but develops an adhesive property when mixed. In the embodiment of FIG. 13, one sphere of encapsulated adhesive 10 contains one of the two-part epoxy components. Hence, if an encapsulant 30 accidentally breaks during storage or transport and the content leaks, there will be no sticky mess. However, upon use, two pieces of encapsulated adhesive 10 would have to be used so that when encapsulant 30 for both pieces break, a first adhesive material 22a and a second adhesive material 22b are released to mix and develop an adhesive property. In the case of FIG. 13, the first adhesive material 22a and the second adhesive material 22b may be a resin and an activator, as are well known in the art. When the dowel 80 is inserted into the cavity 82, the first adhesive material 22a and the second adhesive material 22b will mix in the cavity and fix the dowel 80 in place.

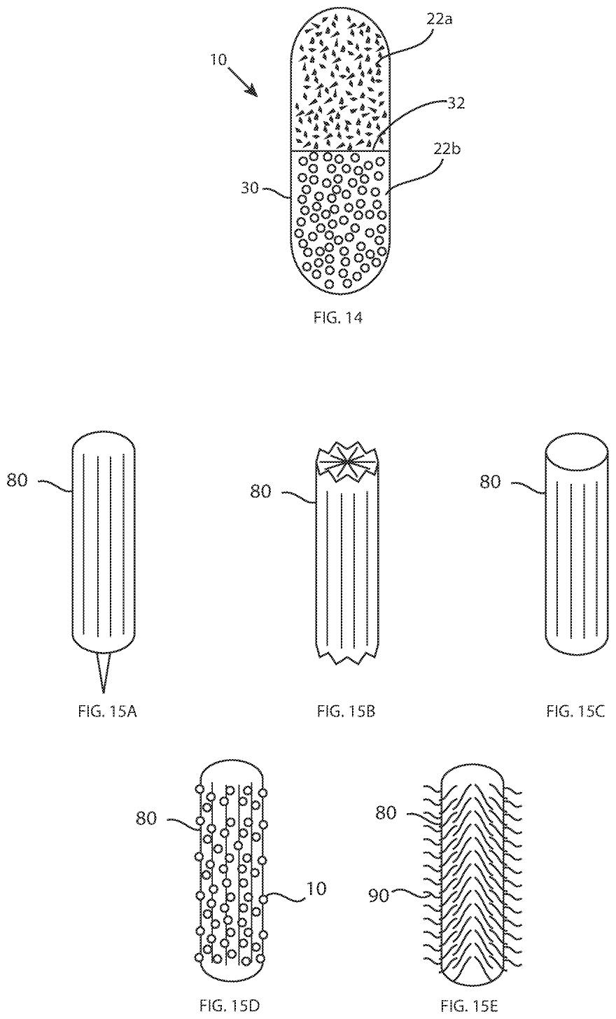

FIG. 14 depicts the encapsulated adhesive 10 in accordance with an embodiment of the inventive concept. This embodiment provides a two-part epoxy packaged in two compartments of a single encapsulated adhesive 10. A separation layer 32 keeps the two types of epoxy contained in the encapsulant 30 from coming into contact with each other. When the encapsulated adhesive 10 breaks, the separation layer 32 may also break, but may not be necessary. The first adhesive material 22a and the second adhesive material 22b mix when the encapsulant 30 and/or the separation layer 32 breaks, and begin to cure. The embodiment of FIG. 14 may be prepared by using a capsule structure as shown in FIG. 4B, then adding a separation layer 32 over one or both of the half-capsule pieces before combining the two pieces.

The two-part epoxy structures of FIG. 13 and FIG. 14 allow the first adhesive material 22a and the second adhesive material 22b to be present in a preselected ratio. For the embodiment of FIG. 13 where the first and second adhesive material 22a, 22b are in separate encapsulants 30, the ratio of the two components may be controlled by the relative sizes of the spheres. The size of the spheres may be controlled by the size of the droplets that fall into the second reactant, referring to the process described in FIG. 3. Alternatively, the size of the sphere may be all the same and the ratio of the components may be controlled by the number of balls of each adhesive material that is used. Using many smaller balls of adhesive, as opposed to two large balls, may result in better mixing of the two parts since the balls may be non-heterogeneously placed. Additionally, the encapsulated adhesives can be color coded, one color for the activator and another color for the resin. Color coding would further assist in applying the proper ratio of activator and resin. For the capsule embodiment of FIG. 14, the relative sizes of the two pieces can be adjusted to achieve the proper ratio of adhesives. It may be preferable to remove and reinsert the dowel or tenon in the hole to ensure adequate mixing of the two part epoxy.

The embodiment of the invention utilizing a two part epoxy adhesive materials in separate encapsulated adhesive may be suitable for bonding dissimilar materials. In one application, metal rods are often affixed to concrete structures by inserting the rods into a hole drilled in the concrete, such as anchoring bolts. The rods are often bonded to the concrete using a two part epoxy adhesive. However, epoxy must be applied within a fixed time after mixing. Alternatively, two part epoxy can be dispense through a caulking gun using a caulking cartridge. Large applications would require mixing several batches of epoxy or multiple caulking cartridges. Use of encapsulated adhesives would avoid mixing batches or changing of caulking cartridges.

FIG. 15A, FIG. 15B, FIG. 15C, FIG. 15D, and FIG. 15E (collectively referred to as “FIG. 15”) depict an embodiment of a dowel that may be used with the encapsulated adhesive 10. FIG. 15A depicts a dowel 80 having one or more spikes 84 that help break the encapsulant 30. FIG. 15B depicts a dowel 80 having a jagged edge designed to break and spread the encapsulated adhesive 10. FIG. 15C depicts a dowel 80 that is made of or include fibers, such as fibers used to make cigarette filter (e.g., cellulose acetate fiber). The fibers naturally have “cracks” or spaces through which the adhesive can seep, causing the dowel 80 to absorb the adhesive and expand, providing a more secure attachment. FIG. 15D depicts a dowel 80 having micro encapsulated adhesives 10 attached to its surface. FIG. 15E depicts fibers attached to the surface of a dowel, similarly to fibers 90 hat are attached to the encapsulant 30 in FIG. 7A. The fibers assist in forming the bond.

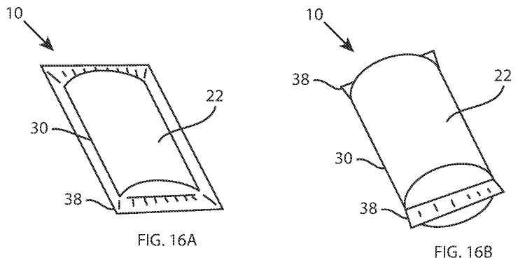

FIG. 16A and FIG. 16B depict an embodiment of an encapsulated adhesive 10 comprised of an encapsulant 30 in the form of a sachet. Adhesive material 22 is dispensed in the sachet and sealed. A fringe 38 may be formed during the sachet forming process, for example at the sealed edges of the sachet material. The fringe 38 may be formed substantially around the perimeter of the encapsulated adhesive 10, as depicted in FIG. 16A, or at the ends, as depicted in FIG. 16B. The fringe 38 can be formed such that the fringe 38 assists in keeping the encapsulated adhesive 10 in whatever hole or cavity it may be placed. For example, in a dowel and hole application, the width of the fringe 38 may be slightly longer than the diameter of the hole into which the encapsulated adhesive 10 is inserted. The fringe 38 may then prevent the encapsulated adhesive 10 from falling out if the hole in the piece is facing down.

The present embodiment can be achieved using a plastic film as the encapsulant 30. Sachet or pouch filling and sealing machines are well known, and can be utilized to fill and seal an encapsulated adhesive 10 according to one embodiment of the present invention. The size, shape and dimensions of the encapsulated adhesive 10 would preferably correspond to the desired application. For example, for a dowel and hole application, the encapsulated adhesive 10 in sachet form would be substantially cylindrical. For a mortise and tenon application, as per another example, the encapsulated adhesive 10 can be a pouch conforming to the rough dimensions of the mortise. A plastic film of approximately 1 mil in thickness (1 mil=one-thousandth of an inch, or 0.0254 millimeter) has been found to be adequate for a dowel and hole application, but any suitable thickness may be utilized for the application such that the encapsulated adhesive may be easily ruptured in the desired application but not during manual handling.

The encapsulated adhesive 10 can, as discussed previously, be scored or partially perforated. The scoring would control the manner which the encapsulant 10 ruptures during application. For dowel and hole application, the encapsulant 10 would preferably rupture radially or upward (i.e., upward out of the hole) to preferably coat the inner walls of the hole and the matching surface of the dowel. Accordingly, scoring or perforations may be applied either on one end of the encapsulated adhesive 10 (to be inserted with the perforations facing upward out of the hole) or along the circumference of the encapsulated adhesive 10 towards the inner wall of the hole. As such, the pattern and location of the scoring or perforations can be adapted accordingly to suit the desired application. Additionally, the use of thicker encapsulants 30 would benefit from scoring or perforations to allow for rupturing during application while still allowing manual handling without rupturing. And, thinner encapsulants 30 may not require scoring or perforations while achieving the same goals.

Various features of the different embodiments presented in this disclosure may be combined. For example, the elongated encapsulated adhesive 10 of FIG. 9 may also have fibers 90 (or any suitable aggregate) as illustrated in FIG. 7 and FIG. 8. An encapsulated adhesive 10 may have the pin 95 inside the encapsulant 30 (as shown in FIG. 10) and also have fibers 90 on the surface (as shown in FIG. 7) or inside the encapsulant 30 (as shown in FIG. 8). Many other combinations are possible.

As discussed, any adhesive may be utilized with an appropriate encapsulant. Any size or shape of the encapsulated adhesive may be formed as suitable for the application. The present invention may also be applied to the bonding any suitable pieces, including without limitation, wood, paper, metal, plastics, ceramics, or alloys, applied to like pieces or dissimilar pieces. It should be understood that the inventive concept can be practiced with modification and alteration within the spirit and scope of the disclosure. The description is not intended to be exhaustive or to limit the inventive concept to the precise form disclosed.

What is claimed is:

1. An encapsulated adhesive comprising:
an adhesive material; and
a non-adhesive encapsulant enclosing and substantially surrounding the adhesive material.

2. The encapsulated adhesive of claim 1, wherein the encapsulant is a layer conformal to the adhesive material and capable of breach, such that the adhesive material is exposed.

3. The encapsulated adhesive of claim 2, wherein upon breach of the encapsulant, the encapsulant breaks up into more than one piece.

4. The encapsulated adhesive of claim 1, wherein a first component of the encapsulant is selected from the group consisting of polymer, calcium alginate, glass, gelatin, ceramic, plastic, polymer, resin and lacquer.

5. The encapsulated adhesive of claim 1 having a shape selected from the group consisting of sphere, cylinder, spherical cylinder, elliptical sphere, polyhedron, prism and pyramid.

6. The encapsulated adhesive of claim 1, further comprising an outer layer.

7. The encapsulated adhesive of claim 1, wherein the outer layer selected from the group consisting of fiberglass, carbon fibers, cellulose, plastic, ceramic and metal.

8. The encapsulated adhesive of claim 1, further comprising an aggregate mixed with the adhesive material and contained inside the encapsulant, the aggregate selected from the group consisting of fiberglass, carbon fibers, cellulose, plastic, ceramic and metal.

9. The encapsulated adhesive of claim 1, further comprising a mechanism contained inside the encapsulant, wherein the mechanism changes shape in response to compression such that the mechanism breaches the encapsulant.

10. A method of bonding, comprising:
forming a first cavity in a first piece;
inserting a first encapsulated adhesive into the first cavity of the first piece, the first encapsulated adhesive containing an adhesive material within an encapsulant; and
inserting a member into the first cavity such that the member breaches the encapsulant and exposes the adhesive material of the first encapsulated adhesive to a surface of the cavity and the member.

11. The method of claim 10, wherein the member is a protrusion of a second piece, wherein the bond is formed between the first and second pieces.

12. The method of claim 10, further comprising:
forming a second cavity in a second piece;
inserting a second encapsulated adhesive into the second cavity of the second piece, the second encapsulated adhesive;
inserting the member into the second cavity such that the member breaches the encapsulant and exposes the adhesive material of the second encapsulated adhesive to a surface of the second cavity and the member.

13. A method of making an encapsulated adhesive, comprising:
forming an encapsulant; and
disposing an adhesive within the encapsulant.

14. The method of claim 13, wherein forming the encapsulant includes:
forming a first portion of an encapsulant layer;
forming a second portion of the encapsulant layer; and
joining the first portion of the encapsulant layer to the second portion of the encapsulant layer such that the encapsulant layer encloses a volume.

15. The method of claim 14, wherein the step of disposing the adhesive is performed during the step of joining the first and second portions of the encapsulant layer, such that the adhesive is disposed within the volume.

16. The method of claim 14, wherein the disposing of the adhesive is performed after the forming of the first portion of the encapsulant layer and before the forming of the second portion of the encapsulant layer.

17. The method of claim 13, wherein the forming of the encapsulant and the disposing of the adhesive within the encapsulant occur simultaneously, including:
mixing an adhesive material with a first reactant to form the adhesive; and
placing the adhesive in contact with a second reactant to form an encapsulant around the adhesive;
wherein each of the first reactant and the second reactant is one of sodium alginate and calcium chloride, whereby the encapsulant is substantially comprised of calcium alginate and encapsulates the adhesive.

18. The method of claim 17, further comprising coating the encapsulated adhesive with one of an uncured acrylic material and an epoxy material to form a shell around the adhesive ball.

19. The method of claim 13, further comprising scoring the encapsulant.

20. The method of claim 13, further comprising attaching at least one of fibers and spikes on the surface of the encapsulant.
